(19) United States
(12) Patent Application Publication
(10) Pub. No.: US 2020/0298838 A1
(43) Pub. Date: Sep. 24, 2020

(54) PARKING GUIDANCE APPARATUS AND PARKING GUIDANCE SYSTEM

(71) Applicant: AISIN SEIKI KABUSHIKI KAISHA, Kariya-shi (JP)

(72) Inventors: Ippei SUGAE, Kariya-shi (JP); Hisashi INABA, Kariya-shi (JP)

(73) Assignee: AISIN SEIKI KABUSHIKI KAISHA, Kariya-shi (JP)

(21) Appl. No.: 16/811,622

(22) Filed: Mar. 6, 2020

(30) Foreign Application Priority Data
Mar. 18, 2019 (JP) 2019-050145

(51) Int. Cl. B60W 30/06

(52) U.S. Cl. CPC B60W 30/06; B60W 2420/54

(57) ABSTRACT

A parking guidance apparatus provided at a vehicle includes a reception processor receiving a transmission wave transmitted from a ground apparatus through at least two onboard receivers fixedly provided at different positions at the vehicle, the at least two onboard receivers including a first onboard receiver and a second onboard receiver, an estimation processor estimating a position of the ground apparatus relative to a position of the vehicle in accordance with a time difference between a first timing and a second timing, the first timing at which the transmission wave is received by the reception processor through the first onboard receiver, the second timing at which the transmission wave is received by the reception processor through the second onboard receiver, and a guide processor specifying a parking area in accordance with the position of the ground apparatus estimated by the estimation processor and guiding the vehicle towards the parking area.

### CROSS REFERENCE TO RELATED APPLICATIONS

This application is based on and claims priority under 35 U.S.C. § 119 to Japanese Patent Application 2019-050145, filed on Mar. 18, 2019, the entire content of which is incorporated herein by reference.

### TECHNICAL FIELD

This disclosure generally relates to a parking guidance apparatus and a parking guidance system.

### BACKGROUND DISCUSSION

Information obtained on a basis of an image of surroundings of a vehicle that is acquired by an onboard camera is provided to guide the vehicle to a predetermine area. Such technique is disclosed, for example, in JP2010-188744A.

The information included in the image usually varies depending on brightness in environment where the image is captured. In a case where a vehicle is guided using the aforementioned technique in autonomous (semi-autonomous) driving, for example, accuracy in guiding the vehicle may vary depending on environment.

A need thus exists for a parking guidance apparatus and a parking guidance system which are not susceptible to the drawback mentioned above.

### SUMMARY

According to an aspect of this disclosure, a parking guidance apparatus provided at a vehicle, the parking guidance apparatus includes a reception processor receiving a transmission wave transmitted from a ground apparatus that is fixedly provided on a ground, the reception processor receiving the transmission wave through at least two onboard receivers fixedly provided at different positions from each other at the vehicle, the at least two onboard receivers including a first onboard receiver and a second onboard receiver that are different from each other, an estimation processor estimating a position of the ground apparatus relative to a position of the vehicle in accordance with a time difference between a first timing and a second timing, the first timing at which the transmission wave is received by the reception processor through the first onboard receiver, the second timing at which the transmission wave is received by the reception processor through the second onboard receiver, and a guide processor specifying a parking area in accordance with the position of the ground apparatus estimated by the estimation processor and guiding the vehicle towards the parking area, the parking area conforming to the position of the ground apparatus.

According to another aspect of this disclosure, a parking guidance apparatus includes a ground apparatus fixedly provided on a ground and transmitting a transmission wave and a parking guidance apparatus provided at a vehicle. The parking guidance apparatus includes a reception processor receiving a transmission wave transmitted from the ground apparatus, the reception processor receiving the transmission wave through at least two onboard receivers fixedly provided at different positions from each other at the vehicle, the at least two onboard receivers including a first onboard receiver and a second onboard receiver that are different from each other, an estimation processor estimating a position of the ground apparatus relative to a position of the vehicle in accordance with a time difference between a first timing and a second timing, the first timing at which the transmission wave is received by the reception processor through the first onboard receiver, the second timing at which the transmission wave is received by the reception processor through the second onboard receiver, and a guide processor specifying a parking area in accordance with the position of the ground apparatus estimated by the estimation processor and guiding the vehicle towards the parking area, the parking area conforming to the position of the ground apparatus.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating a configuration of a parking guidance system according to an embodiment disclosed here;

FIG. 2 is a block diagram illustrating configurations of a parking guidance apparatus and a ground apparatus according to the embodiment;

FIG. 3 is a schematic view illustrating an example where the parking guidance apparatus receives a transmission wave from a guide device through object detectors according to the embodiment;

FIG. 4 is a schematic view illustrating a first method employed by the parking guidance apparatus for estimating a position of the guide device according to the embodiment;

FIG. 5 is a schematic view illustrating a second method employed by the parking guidance apparatus for estimating a position of the guide device according to the embodiment;

FIG. 6 is a schematic view illustrating a third method employed by the parking guidance apparatus for estimating a position of the guide device according to the embodiment;

FIG. 7 is a schematic view illustrating an example where the parking guidance apparatus receives a transmission wave from a stopper device according to the embodiment; and

FIG. 8 is a flowchart illustrating a processing executed by the parking guidance apparatus and the ground apparatus according to the embodiment.

### DETAILED DESCRIPTION

An embodiment is explained with reference to the attached drawings. Configurations of the embodiment, and effects and results derived from such configurations are examples and are not limited to descriptions below.

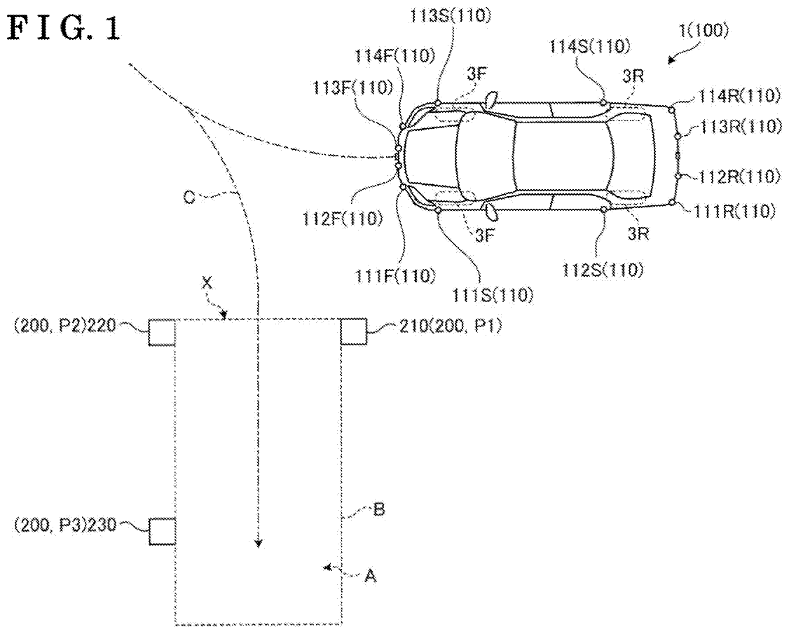

As illustrated in FIG. 1, a parking guidance system according to the embodiment guides a vehicle 1 to be parked or halted in autonomous (semi-autonomous) driving within a parking area A provided on the ground and serving as a predetermined region where the vehicle 1 is parked or halted.

As illustrated in FIG. 1, the parking guidance system according to the embodiment includes a parking guidance apparatus 100 serving as an onboard apparatus that is mounted at the vehicle 1 including a pair of front wheels 3F and a pair of rear wheels 3R, and a ground apparatus 200 provided on the ground so as to conform to the parking area A.

The parking guidance apparatus 100 is mounted inside the vehicle 1 to serve as an electronic control unit (ECU) corresponding to a microcomputer that includes the same or similar hardware for a typical computer, such as a central processing unit and memory, for example. The parking guidance apparatus 100 brings the vehicle 1 to be parked within the parking area A after the vehicle 1 enters through an entrance X in autonomous (semi-autonomous) driving along a path C illustrated in FIG. 1, for example, using plural object detectors 110 provided on an exterior of the vehicle 1.

As illustrated in FIG. 1, for example, the plural object detectors 110 include four object detectors 111F, 112F, 113F, and 114F provided at a front end part of the vehicle 1, four object detectors 111R, 112R, 113R, and 114R provided at a rear end part of the vehicle 1, two object detectors 111S and 112S provided at a left end part of the vehicle 1, and two object detectors 113S and 114S provided at a right end part of the vehicle 1. Each of the object detectors 110 is constituted by a sonar that detects information related to an object that may be positioned in surroundings of the vehicle 1, specifically, detects a distance thereto by transmitting and receiving ultrasonic waves.

According to the present embodiment, arrangements and the number of object detectors 110 are not limited to those illustrated in FIG. 1 and may be appropriately specified and changed.

The ground apparatus 200 is placed in the vicinity of a boundary B (i.e., a rectangle indicated with a broken line in FIG. 1) of the parking area A. Specifically, the ground apparatus 200 includes guide devices 210 and 220 provided at positions P1 and P2 abutting on the boundary B of the parking area A, and a stopper device 230 provided at a position P3 abutting on the boundary B of the parking area A. Each of the guide devices 210 and 220 serves as a first ground device and the stopper device 230 serves as a second ground device.

The positions P1 and P2 correspond to opposed ends of the entrance X in a width direction thereof, the entrance X through which the vehicle 1 enters the parking area A. In FIG. 1, the entrance X is positioned at an upper end portion (upper side) of the rectangle indicated with the broken line corresponding to the boundary B of the parking area A. The parking area A is thus defined to be a rectangular area with a predetermined space including the end portion formed by the entrance X.

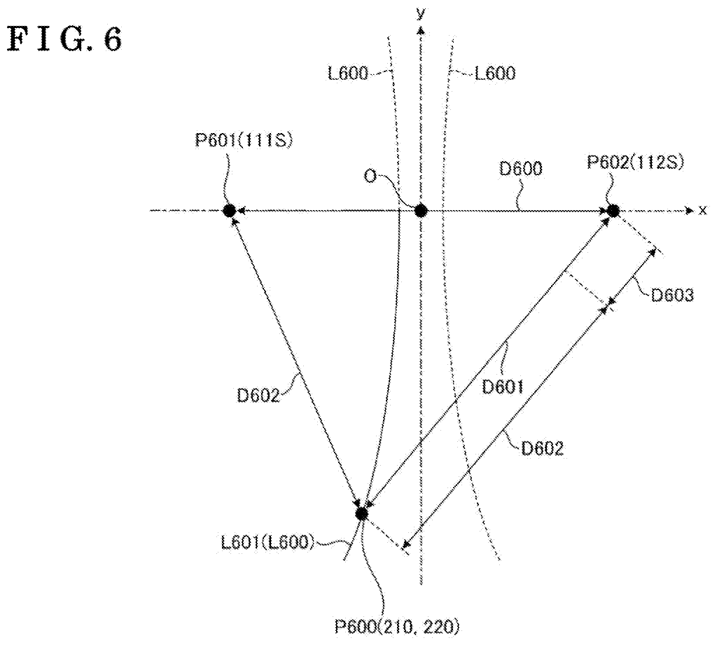

The position P3 is away from the position P1 by a predetermined distance in a direction where the vehicle 1 enters the parking area A (i.e., an entry direction of the vehicle 1, refer to an arrow provided at an end of the path C illustrated in FIG. 1). The position P3 is specified to be opposed to the object detector 112S of the vehicle 1 in a state where the vehicle 1 is positioned within the parking area A (see FIG. 6) after entering the parking area A.

In FIG. 1, the positions P1, P2, and P3 are all disposed abutting on the boundary B of the parking area A. Instead, the positions P1, P2, and P3 may be away from the boundary B of the parking area to a certain amount as long as the positions P1, P2, and P3 are placed in the vicinity of the boundary B of the parking area A.

According to a known technique, information obtained on a basis of an image of surroundings of a vehicle that is acquired by an onboard camera is provided to guide the vehicle to a predetermine area.

The information included in the image usually varies depending on brightness in environment where the image is captured. In a case where a vehicle is guided using the aforementioned technique in autonomous (semi-autonomous) driving, for example, accuracy in guiding the vehicle may vary depending on environment.

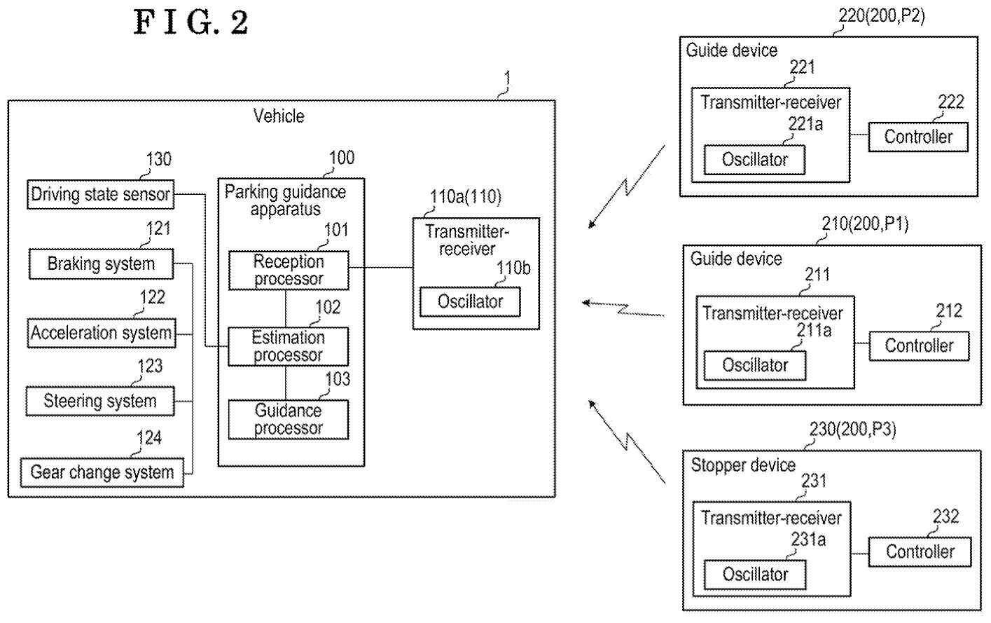

The parking guidance system according to the present embodiment enables the vehicle 1 to be accurately guided with no influence of environment in a state where the parking guidance apparatus 100 mounted at the vehicle 1 and the ground apparatus 200 provided on the ground operate together with functions as illustrated in FIG. 2 (or hardware).

As illustrated in FIG. 2, in the present embodiment, the ground apparatus 200 includes the guide devices 210, 220, and the stopper device 230.

The guide devices 210, 220, and the stopper device 230 of the ground apparatus 200 are explained below.

The guide device 210 includes a transmitter-receiver 211 and a controller 212. The guide device 220 includes a transmitter-receiver 221, a controller 222, and a communicator. The stopper device 230 includes a transmitter-receiver 231, a controller 232, and a communicator.

Components having identical names include the same functions and operations. In the following, the construction of the guide device 210 of the ground apparatus 200 provided at the position P1 illustrated in FIG. 1 is explained as an example.

The transmitter-receiver 211 includes an oscillator 211a including a piezoelectric element, for example, that oscillates to receive and transmit ultrasonic waves. The transmitter-receiver 211 at least functions as a ground transmitter that transmits the ultrasonic wave from the ground.

The controller 212 controls the guide device 210. The controller 212 controls transmission and reception of ultrasonic waves performed by the transmitter-receiver 211 and communication performed by the communicator, for example.

The oscillator 211a of the transmitter-receiver 211 of the guide device 210 and an oscillator 221a of the transmitter-receiver 221 of the guide device 220 transmit transmission waves serving as ultrasonic waves at least in a direction opposite to the entry direction of the vehicle 1 to the entrance X of the parking area A. At this time, the transmission wave from the transmitter-receiver 211 and the transmission wave from the transmitter-receiver 221 are transmitted so as not to interfere with each other. An oscillator 231a of the transmitter-receiver 231 of the stopper device 230 transmits a transmission wave (ultrasonic wave) in a different direction from the direction where the transmission wave is transmitted from each of the transmitter-receivers 211 and 221.

A construction of the parking guidance apparatus 100 is explained below.

As illustrated in FIG. 2, the parking guidance apparatus 100 includes a reception processor 101, an estimation processor 102, and a guide processor 103. The reception processor 101, the estimation processor 102, and the guide processor 103 may be partially or fully achieved in function by co-operation of hardware and software, specifically, by a processor of the ECU constituting the parking guidance apparatus 100 to read and execute program stored at a memory, or achieved by hardware such as an exclusive circuit, for example.

The reception processor 101 controls reception of ultrasonic waves through transmitter-receivers 110a provided at the respective object detectors 110. Each of the transmitter-receivers 110a is provided as a device such as a piezoelectric element, for example, for transmitting and receiving the ultrasonic wave. The transmitter-receiver 110a includes an oscillator 110b including a piezoelectric element, for example, that oscillates to receive and transmit the ultrasonic wave. The transmitter-receiver 110a thus at least functions as an onboard receiver receiving the ultrasonic wave at the vehicle 1 from the ground apparatus 200.

The estimation processor 102 performs an estimation processing for estimating positions of the guide devices 210 and 220 relative to the position of the vehicle 1 in accordance with an output value of a driving state sensor 130 that detects a driving state of the vehicle 1 and a reception result of transmission waves transmitted from the ground apparatus 200, the reception result being obtained by the reception processor 101. The driving state sensor 130 includes a wheel speed sensor that detects a rotation speed (the number of rotations) of each front wheel 3F and rear wheel 3R and a steering angle sensor that detects a steering angle of the vehicle 1, for example. The output value of the driving state sensor 130 is usable for calculations of the present position of the vehicle 1 and a moving distance of the vehicle 1 by odometry, for example.

The guide processor 103 specifies the entrance X through which the vehicle 1 is expected to enter and the parking area A including the entrance X as illustrated in FIG. 1, for example, in accordance with the positions of the guide devices 210 and 220 estimated by the estimation processor 102 to perform a guidance control for guiding the vehicle 1 in autonomous (semi-autonomous) driving towards the entrance X and the parking area A. The autonomous (semi-autonomous) driving in the guidance control is achieved by controlling a driving control system mounted at the vehicle 1. The driving control system includes a braking system 121 controlling braking of the vehicle 1, an acceleration system 122 controlling acceleration of the vehicle 1, a steering system 123 controlling steering of the vehicle 1, and a gear change system 124 controlling gear change of the vehicle 1, for example.

According to the present embodiment, the guidance control is achieved as explained below by cooperation between the parking guidance apparatus 100 and the ground apparatus 200.

The reception processor 101 of the parking guidance apparatus 100 receives transmission waves transmitted from the guide devices 210 and 220 of the ground apparatus 200 through the transmitter-receivers 110a of the plural (specifically, two) object detectors 110 provided at a lateral end portion of the vehicle 1 in the following manner for achieving the guidance control performed by the guide processor 103.

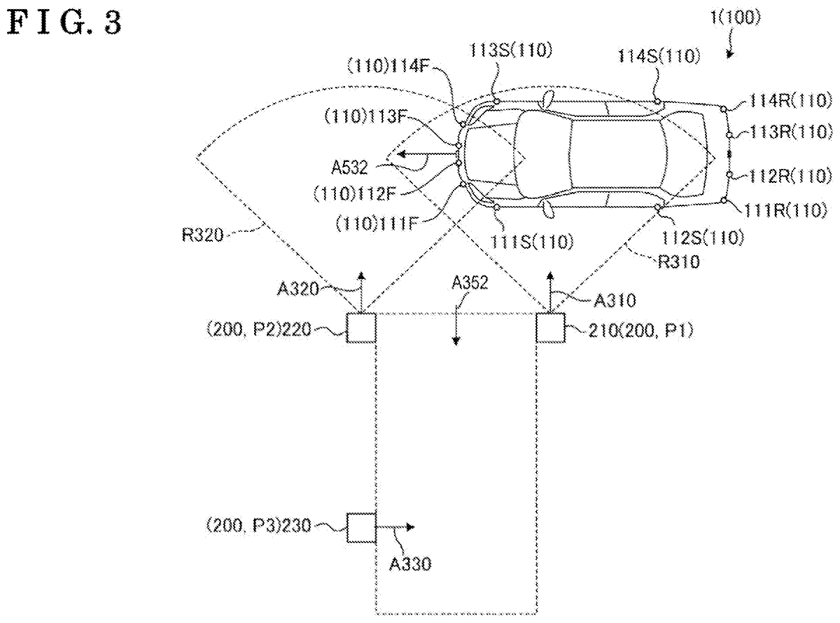

As illustrated in FIG. 3, the guide device 210 transmits the transmission wave to a range R310 that expands from the position P1 with the center constituted by an arrow A310 that extends in an opposite direction to an arrow A352 indicating an entry direction of the vehicle 1 to the entrance X, for example. The guide device 220 transmits the transmission wave to a range R320 that expands from the position P2 with the center constituted by an arrow A320 in an opposite direction to the arrow A352, for example.

In a case where the vehicle 1 moves along a direction indicated by an arrow A532 to cross the front of the guide device 210 as illustrated in FIG. 3, both the object detectors 111S and 112S provided at the left end portion of the vehicle 1 opposed to the guide device 210 are brought to be positioned within the range R310 serving as a transmission range of the transmission wave from the guide device 210. At this time, the estimation processor 102 of the parking guidance apparatus 100 estimates the position of the guide device 210 using any of three methods explained below in accordance with a time difference between a first timing and a second timing. Specifically, the transmission wave from the guide device 210 is received at the first timing through the object detector 111S serving as the first onboard receiver. Additionally, the transmission wave from the guide device 220 is received at the second timing through the object detector 112S serving as the second onboard receiver.

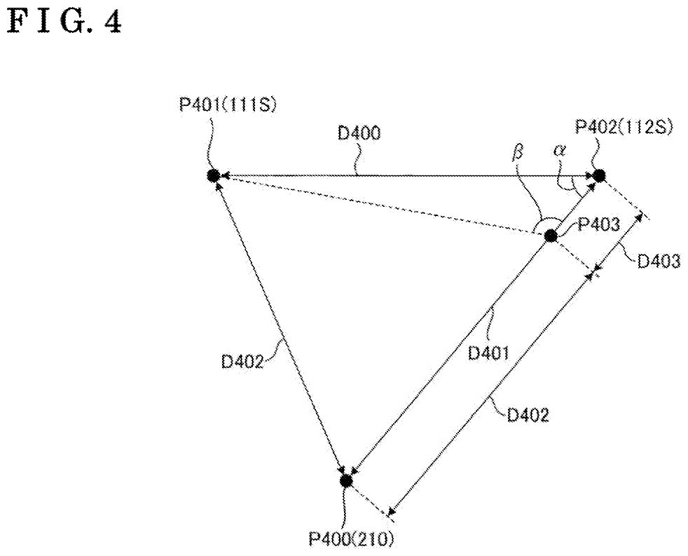

A first method employed by the parking guidance apparatus 100 for estimating the position of the guide device 210 is explained with reference to FIG. 4. In an example illustrated in FIG. 4, a point P400 corresponds to the position of the guide device 210, a point P401 corresponding to the position of the object detector 111S, a point P402 corresponding to the position of the object detector 112S. A distance D401 between the points P400 and P402 corresponds to a transmission distance of the transmission wave between the guide device 210 and the object detector 112S. A distance D402 between the points P400 and P401 corresponds to a transmission distance of the transmission wave between the guide device 210 and the object detector 111S.

As illustrated in FIG. 4, a distance D403 is defined as a distance difference between the distance D401 and the distance D402. Such distance difference corresponds to a value obtained by multiplying a time difference between the first timing and the second timing by speed of sound. The distance difference is thus acquirable by measuring the time difference.

A distance D400 between the points P401 and P402 corresponds to an interval between the object detectors 111S and 112S. Such interval is acquirable as a predetermined value based on specifications of the vehicle 1.

The position of the guide device 210 relative to the position of the vehicle 1 is calculated (estimated) with the distance D400 and the distance D403. An angle α indicating the direction of the guide device 210 relative to the vehicle 1 is approximately calculated by the following calculation using the distances D400 and D403.

Specifically, a distance between the vehicle 1 and the guide device 210 is sufficiently small relative to a distance by which the transmission wave moves (transfers) per time unit under circumstances which are expected or assumed in the embodiment. A triangle formed by the point P401, the point P402, and the point P403 that is away from the point P402 by the distance D403 towards the point P400 may be approximated to a right triangle with an angle β at the point P403. The aforementioned approximation leads to a relational expression of cos α=D403/D400. The angle α indicating the direction of the guide device 210 relative to the vehicle 1 is thus calculated using the distance D400 and the distance D403.

The distance D401 and the distance D402 are calculated by the following calculation using the distance D400, the distance D403, and the angle β. The position of the guide device 210 relative to the vehicle 1 is calculated accordingly.

Specifically, the distance D403 between the point P402 and the point P403 corresponds to the time difference between the first timing and the second timing. Thus, the distance D402 between the point P400 and the point P401 and a distance between the point P400 and the point P403 (i.e., a distance D401-D403) satisfies a formula: D402=D401−D403. Additionally, a formula (D402)²=(D400)²+(D401)²−2×D400×D401×cos α is established by cosine formula for a relationship between the distance D400 and the distance D401. The distance D401 and the distance D402 indicating the position of the guide device 210 relative to the vehicle 1 are thus calculated in the aforementioned formulas using the angle α, the distance D400, and the distance D403.

The estimation processor 102 when employing the first method acquires the time difference between the first timing at which the transmission wave is received through the object detector 111S and the second timing at which the transmission wave is received through the object detector 112S in a state as illustrated in FIG. 3 where the transmission wave from the guide device 210 reaches both the object detectors 111S and 112S. The estimation processor 102 then calculates the distance difference between the transmission distance of the transmission wave between the guide device 210 and the object detector 111S (i.e., a first transmission distance) and the transmission distance of the transmission wave between the guide device 210 and the object detector 112S (i.e., a second transmission distance) in accordance with the time difference and estimates the position of the guide device 210 relative to the vehicle 1 from the distance difference.

The first method is usable in a state where the two object detectors 110 receive the transmission wave from the same guide device of the ground apparatus 200. For example, when the vehicle 1 further moves along the direction indicated by the arrow A532 in FIG. 3, both the object detectors 111S and 112S are positioned within the range R320 serving as a transmission range of the transmission wave from the guide device 220. In such state, the estimation processor 102 estimates the position of the guide device 220 relative to the vehicle 1 by the first method based on the time difference between the first timing at which the transmission wave is received through the object detector 111S and the second timing at which the transmission wave is received through the object detector 112S.

In FIG. 3, a state where the object detector 111S is positioned within the range R320 and the object detector 112S is positioned within the range R310 is presumable. The first method is not applicable to such state because the transmission wave from the guide device 220 and the transmission wave from the guide device 210 are received respectively by the two object detectors 111S and 112S.

In FIG. 3, the range R310 and the range R320 partially overlap each other. Thus, the transmission wave from the guide device 210 and the transmission wave from the guide device 220 are expected to be both received by the same object detector 110. In this case, the transmission wave from the guide device 210 and the transmission wave from the guide device 220 interfere with each other, which may inhibit the parking guidance apparatus 100 from identifying the guide devices 210 and 220.

In light of the foregoing, the guide devices 210 and 220 according to the embodiment transmit the respective transmission waves that are coded to include different identification information from each other so as to restrain the aforementioned interference. The parking guidance apparatus 100 identifies the transmission wave from the guide device 210 and the transmission wave from the guide device 220 accordingly. The other method than using the identification information for restraining the interference may include appropriately adjusting directionality of transmission waves from the guide devices 210 and 220 so as to minimize the overlapping area of transmission ranges thereof.

According to the first method, in a case where the state where the transmission wave from the guide device 210 is received by the two object detectors 110 (111S and 112S) and the state where the transmission wave from the guide device 220 is received by the two object detectors 110 (111S and 112S) occur one time each, the positons of the guide devices 210 and 220 are able to be estimated. The first method thus achieves simple and prompt processing.

Nevertheless, the state where the transmission wave from the guide device 210 is received by the two object detectors 110 may occur twice or more and the state where the transmission wave from the guide device 220 is received by the two object detectors 110 may occur twice or more.

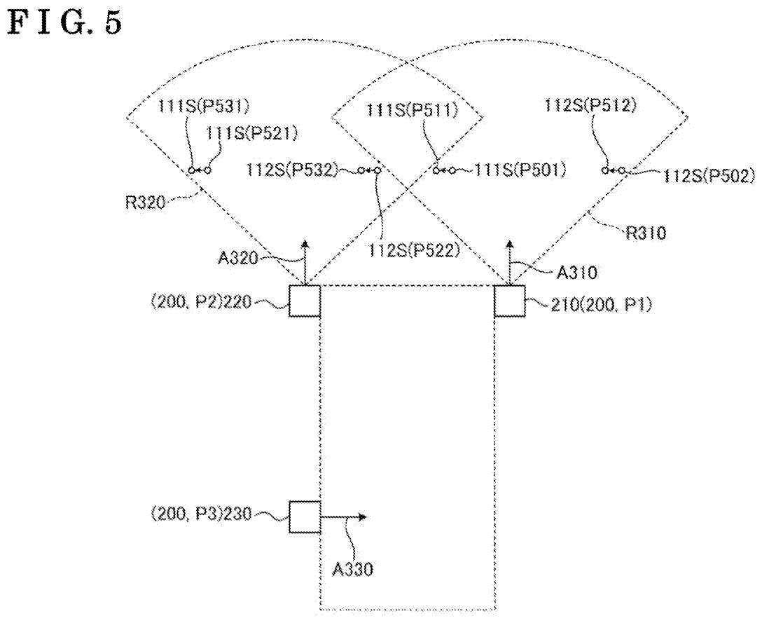

Thus, according to the embodiment, the estimation of the position of each of the guide devices 210 and 220 by the first method is performed at least twice as illustrated in FIG. 5, so that the position of each of the guide devices 210 and 220 is more accurately estimated on a basis of more information.

A second method employed by the parking guidance apparatus 100 for estimating the positions of the guide devices 210 and 220 is explained with reference to FIG. 5. In FIG. 5, the object detectors 111S and 112S are only illustrated as the configuration of the vehicle 1 for purposes of simple explanation.

First, the estimation of the position of the guide device 210 in the second method is explained. As illustrated in FIG. 5, the estimation processor 102 estimates the direction of the guide device 210 relative to the vehicle 1 using the similar approximation to the first method in a first case where the object detectors 111S and 112S are placed at a position P501 and a position P502 respectively and in a second case where the object detectors 111S and 112S are placed at a position P511 and a position P512 with the movement of the vehicle 1. The aforementioned direction of the guide device 210 serves as information corresponding to the angle α illustrated in FIG. 4, for example.

The estimation processor 102 estimates a candidate for the position of the guide device 210 in accordance with the direction that is estimated in each of the first case and the second case. The candidate for the position of the guide device 210 serves as information corresponding to a straight line passing through the point P400 and the point P402 illustrated in FIG. 4, for example.

The estimation processor 102 then estimates a point where the candidate for the position of the guide device 210 estimated in the first case and the candidate for the position of the guide device 210 estimated in the second case conform to each other as the actual position of the guide device 210. At this time a positional relation between a first position serving as the position of the vehicle 1 in the first case and a second position serving as the position of the vehicle 1 in the second case needs to be obtained. Such positional relation is obtainable from a moving distance of the vehicle 1 between the first position and the second position that is calculated on a basis of an output value of the driving state sensor 130.

The position of the guide device 210 is accurately estimated using the two estimation results according to the second method.

The estimation of the position of the guide device 220 according to the second method is performed in the same manner as above. Specifically, as illustrated in FIG. 5, the estimation processor 102 estimates the direction of the guide device 220 in the first case where the object detectors 111S and 112S are placed at positions P521 and P522 and the direction of the guide device 220 in the second case where the object detectors 111S and 112S have moved to positions P531 and P532 with the movement of the vehicle 1. The estimation processor 102 estimates a candidate for the position of the guide device 220 in accordance with each of the aforementioned directions. The estimation processor 102 then estimates a point where the candidate for the position of the guide device 220 estimated in the first case and the candidate for the position of the guide device 220 estimated in the second case conform to each other as the actual position of the guide device 220.

The second method is similar to the first method in terms of usage of approximation to estimate the direction of each of the guide devices 210 and 220 for estimating each position of the guide devices 210 and 220. Thus, there is yet room for improving accuracy of estimation of positions of the guide devices 210 and 220 in the second method.

The estimation processor 102 of the parking guidance apparatus 100 according to the embodiment accurately estimates positions of the guide devices 210 and 220 as illustrated in FIG. 6 without using the approximation utilized in the first method and the second method.

A third method employed by the parking guidance apparatus 100 for estimating the positions of the guide devices 210 and 220 is explained with reference to FIG. 6. A point P600 corresponds to the position of the guide device 210 or 220, a point P601 corresponding to the position of the object detector 111S, a point P602 corresponding to the position of the object detector 112S. A distance D601 between the points P600 and P602 corresponds to a transmission distance of the transmission wave between the guide device 210 or 220 and the object detector 112S. A distance D602 between the points P600 and P601 corresponds to a transmission distance of the transmission wave between the guide device 210 or 220 and the object detector 111S.

A distance D603 serving as a distance difference between the distance D601 and the distance D602 is calculated on a basis of a time difference between the first timing at which the transmission wave from the guide device 210 or 220 is received through the object detector 111S and the second timing at which the transmission wave from the guide device 210 or 220 is received through the object detector 112S in the same manner as the first and second methods.

Mathematically, a point that satisfies a condition where a difference between distances from such point to two given points is constant is positioned on a hyperbola with foci constituted by the aforementioned two points. In FIG. 6, the point P600 that satisfies a condition where a difference between distances from the point P600 to the points P601 and P602 is constantly equal to the distance D603 is located on a hyperbola L600 with foci constituted by the points P601 and P602 in x-y coordinate including an origin ◯ that is a middle point between the point P601 and the point P602.

In FIG. 6, the object detectors 111S and 112S are arranged at a left end portion of the vehicle 1 and the distance D601 is longer than the distance D602. The point P600 is thus supposed to be on one curve L601 of the hyperbola L600 (i.e., a part of the hyperbola L600). The one curve L601 of the hyperbola L600 is estimated as a candidate for the position of the guide device 210 or 220.

According to the third method, the hyperbola (or a part thereof) that satisfies the aforementioned condition is specified for each of the guide devices 210 and 220 at least two times. An intersection of the two hyperbolas specified for the guide device 210 is estimated to be an actual position of the guide device 210. Additionally, an intersection of the two hyperbolas specified for the guide device 220 is also estimated to be an actual position of the guide device 220.

In the third method, a positional relation between the position of the vehicle 1 obtained when the hyperbola is specified first time (i.e., the first position) and the position of the vehicle 1 obtained when the hyperbola is specified second time (i.e., the second position) is necessarily acquired in the same way as the second method. Such positional relation is acquirable from the moving distance of the vehicle 1 between the first position and the second position that is calculated on a basis of an output value of the driving state sensor 130.

According to the embodiment, the estimation processor 102 of the parking guidance apparatus 100 estimates, in any of the first to third methods, the position of each of the guide devices 210 and 220 based on a time difference between the first timing at which the transmission wave from the guide device 210, 220 is received through the object detector 111S serving as the first onboard receiver and the second timing at which the transmission wave from the guide device 210, 220 is received through the object detector 112S serving as the second onboard receiver.

Specifically, the estimation processor 102 calculates, in any of the first to third methods, a distance difference between the transmission distance of the transmission wave between the guide device 210, 220 and the object detector 111S and the transmission distance of the transmission wave between the guide device 210, 220 and the object detector 112S in accordance with a time difference between the first timing and the second timing. The estimation processor 102 then estimates the position of the guide device 210, 220 in accordance with the aforementioned distance difference.

Specifically, in the first method, the estimation processor 102 estimates the position of each of the guide devices 210 and 220 using the aforementioned approximation by calculating one time the distance difference based on the time difference in the aforementioned manner.

Additionally, in the second and third methods, the estimation processor 102 calculates at least twice the distance difference based on the time difference in the aforementioned manner for each of the guide devices 210 and 220. The estimation processor 102 estimates a candidate for the position of each of the guide devices 210 and 220 in accordance with the aforementioned distance difference. The estimation processor 102 estimates the position of each of the guide devices 210 and 220 based on a first candidate estimated first, a second candidate estimated second, and a positional relation between the position of the vehicle 1 obtained at the first estimation and the position of the vehicle 1 obtained at the second estimation. In the second method, the approximation similar to the first method is utilized to estimate the positions of the guide devices 210 and 220. In the third method, the positions of the guide devices 210 and 220 are estimated using the hyperbola, without using the approximation.

In the aforementioned explanation for the first to third methods, the positions of the guide devices 210 and 220 are estimated using the object detectors 111S and 112S provided at the left end portion of the vehicle 1. Alternatively, the positions of the guide devices 210 and 220 may be estimated using the other object detectors than the object detectors 111S and 112S in a state where such object detectors are able to receive transmission waves from the guide devices 210 and 220. The number of object detectors 110 used for estimating the position of each of the guide devices 210 and 220 is not limited to two. The position of the guide device 210, 220 may be estimated with three or more than three object detectors 110, for example.

The reception processor 101 may control the object detectors 111S and 112S to tentatively stop transmission of transmission waves for detecting the distance as sonars and to exclusively serve as receivers, so that reception of reception waves from the guide devices 210 and 220 is not disturbed. Such operation may be triggered by a predetermined operation by a driver to start the guide control, for example.

In a case where the positons of the guide devices 210 and 220 are estimated, the guide processor 103 specifies the entrance X where the vehicle 1 is expected to enter and the parking area A including the entrance X. Specifically, the guide processor 103 specifies the entrance X on the assumption that the positions of the guide devices 210 and 220 correspond to the opposed ends of the entrance X. The guide processor 103 specifies the parking area A based on the specified entrance X in accordance with the definition that the parking area A is a rectangular area with a predetermined space including the entrance X as an end portion.

The guide processor 103 determines an entry line of the vehicle 1 to the parking area A via the entrance X and starts the guide control so that the vehicle 1 enters the parking area A from the entrance X along the aforementioned entry line. The entry line includes a position or a direction of the vehicle 1 so that the vehicle 1 is inhibited from deviating from the opposed ends of the entrance X when entering the entrance X in autonomous (semi-autonomous) driving.

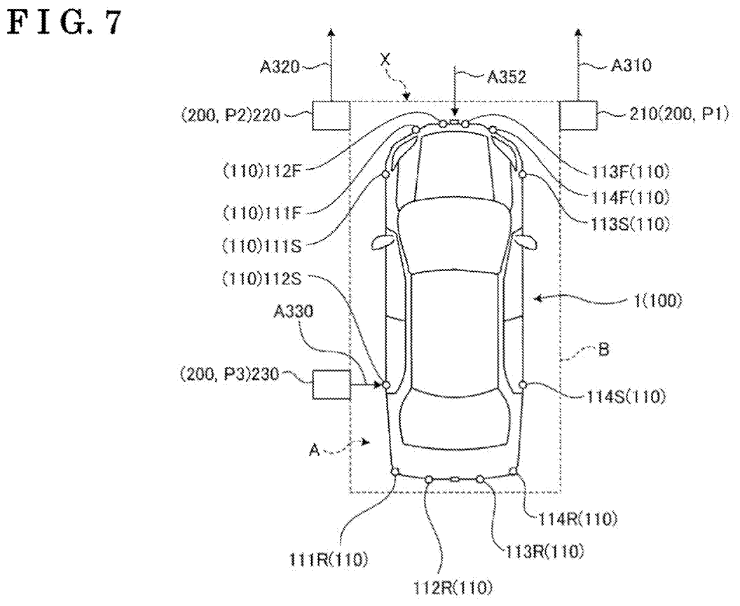

In the embodiment, the ground apparatus 200 includes the stopper device 230 in addition to the guide devices 210 and 220. The stopper device 230 is also able to transmit the transmission wave. The transmission wave transmitted from the stopper device 230 is usable to halt or park the vehicle 1 at a predetermined position within the parking area A in a manner illustrated in FIG. 7 after the vehicle 1 enters through the entrance X.

In FIG. 7, the parking guidance apparatus 100 according to the embodiment receives the transmission wave from the stopper device 230. The vehicle 1 is positioned within the parking area A by moving along the entry direction indicated by the arrow A352 to enter the parking area A through the entrance X in autonomous (semi-autonomous) driving.

The stopper device 230 is arranged to be opposed to the object detector 112S of the vehicle 1 when the vehicle 1 is positioned within the parking area A. At timing where the vehicle 1 reaches a position within the parking area A corresponding to the position P3 of the stopper device 230 as illustrated in FIG. 7, the signal level of the transmission wave from the stopper device 230 (see an arrow A330) shows a peak level, the transmission wave being received through the object detector 112S provided at the left end portion of the vehicle 1. The guide control that is terminated at the aforementioned timing enables the vehicle 1 to be appropriately stopped within the parking area A so as not to deviate therefrom.

In the embodiment, the reception processor 101 continues to receive the transmission wave from the ground apparatus 200 (specifically, the stopper device 230) after the vehicle 1 enters the parking area A. The guide processor 103 terminates the guide control to stop (park) the vehicle 1 around timing where the signal level of the transmission wave from the stopper device 230 shows a peak level.

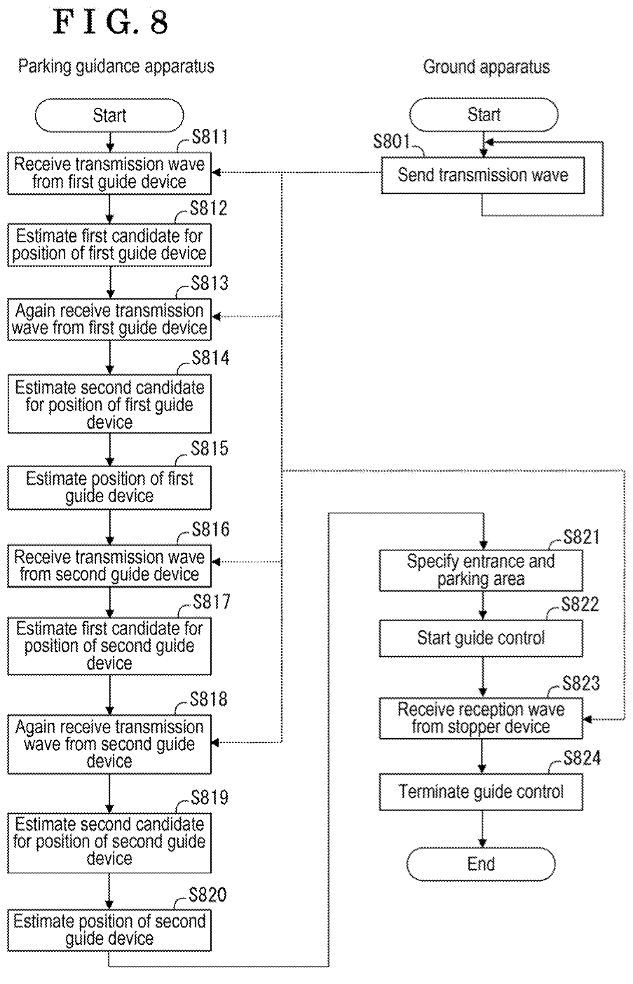

The parking guidance apparatus 100 and the ground apparatus 200 according to the embodiment including the aforementioned configurations perform a processing as illustrated in FIG. 8. In the following, the second or third method is employed for estimating the positions of the guide devices 210 and 220.

As illustrated in a flowchart in FIG. 8, the guide devices 210, 220, and the stopper device 230 of the ground apparatus 200 transmit transmission waves at S801. In FIG. 8, the transmission waves from the ground apparatus 200 are repeatedly transmitted. Instead, the transmission of the transmission waves may be started or finished in response to some trigger such as a reception of instruction from the parking guidance apparatus 100, for example.

The reception processor 101 of the parking guidance apparatus 100 receives the transmission wave from one of the guide devices 210 and 220 arranged at the opposed ends of the entrance X, specifically, receives the transmission wave from one of the guide devices 210 and 220 positioned closer to the vehicle 1 at S811. In the following explanation, the transmission wave from the guide device 210 is received at the reception processor 101 as an example.

The estimation processor 102 of the parking guidance apparatus 100 estimates the first candidate for the position of the guide device 210 at S812 using the second or third method in accordance with the reception result of the transmission wave obtained at S811.

The reception processor 101 of the parking guidance apparatus 100 again receives the transmission wave from the guide device 210 at S813. At this time, it is a precondition that the position of the vehicle 1 at the time of reception of the transmission wave at S813 is different from the position of the vehicle 1 at the time of reception of the transmission wave at S811.

The estimation processor 102 of the parking guidance apparatus 100 estimates the second candidate for the position of the guide device 210 at S814 using the second or third method in accordance with the reception result of the transmission wave at S813.

The estimation processor 102 of the parking guidance apparatus 100 then estimates at S815, as the position of the guide device 210, a position where the estimation result obtained at S812 and the estimation result obtained at S814 conform to each other while reflecting the moving distance of the vehicle 1 from S812 to S814.

The parking guidance apparatus 100 performs a processing in the same manner as S811 to S815 for the other one of the guide devices 210 and 220 of which position is not yet estimated (i.e., the guide device 220 in FIGS. 8) at S816 to S820.

Specifically, the reception processor 101 of the parking guidance apparatus 100 receives the transmission wave from the guide device 220 at S816 and estimates the first candidate for the position of the guide device 220 at S817 in accordance with the reception result obtained at S816.

The reception processor 101 of the parking guidance apparatus 100 again receives the transmission wave from the guide device 220 at S818 and estimates the second candidate for the position of the guide device 220 at S819 in accordance with the reception result of the transmission wave obtained at S818.

The estimation processor 102 of the parking guidance apparatus 100 then estimates at S820, as the position of the guide device 220, a position where the estimation result obtained at S817 and the estimation result obtained at S819 conform to each other while reflecting the moving distance of the vehicle from S817 to S819.

The guide processor 103 of the parking guidance apparatus 100 specifies at S821, the entrance X and the parking area A in accordance with the estimation result obtained at S815 and the estimation result obtained at S820.

The guide processor 103 of the parking guidance apparatus 100 then starts the guide control for guiding the vehicle 1 to enter the parking area A through the entrance X along the entry line at S822. Specifically, the guide processor 103 determines the entry line indicating the position and/or the direction of the vehicle 1 so that the vehicle 1 is inhibited from deviating from the opposed ends of the entrance X in autonomous (semi-autonomous) driving when the vehicle 1 enters the entrance X, in accordance with the entrance X and the parking area A which are specified at S821. The guide processor 103 then starts the guide control.

The reception processor 101 of the parking guidance apparatus 100 receives the transmission wave from the stopper device 230 at S823.

The guide processor 103 of the parking guidance apparatus 100 terminates the guide control around or in the vicinity of timing at which the signal level of the transmission wave received at S823 shows the peak level at S824. The vehicle 1 is stopped or parked at an appropriate position within the parking area A. The present processing is terminated accordingly.

The parking guidance apparatus 100 according to the embodiment mounted at the vehicle 1 includes the reception processor 101, the estimation processor 102, and the guide processor 103. The reception processor 101 receives transmission waves transmitted from the guide devices 210 and 220 serving as the ground apparatus 200 and being provided fixedly on the ground, through at least two object detectors 110 serving as the two onboard receivers and being provided at different positions from each other at the vehicle 1. The estimation processor 102 estimates positions of the guide devices 210 and 220 relative to the vehicle 1 in accordance with the time difference between the first timing at which the transmission wave is received by the reception processor 101 through one object detector 110 serving as the first onboard receiver and the second timing at which the transmission wave is received by the reception processor 101 through another object detector 110 serving as the second onboard receiver. The guide processor 103 specifies the parking area A provided conforming to the positions of the guide devices 210 and 220 in accordance with the positions of the guide devices 210 and 220 estimated by the estimation processor 102 to guide the vehicle 1 towards the parking area A.

Specifically, the reception processor 101 receives, through at least the aforementioned two object detectors 110, the transmission wave transmitted from each of the guide devices 210 and 220 serving as the ground apparatus 200 and arranged at positions corresponding to the opposed ends of the entrance X opposed in the width direction thereof. The guide processor 103 estimates the position of the guide device 210 based on the transmission wave transmitted from the guide device 210 and estimates the position of the guide device 220 based on the transmission wave transmitted from the guide device 220. The guide processor 103 specifies the entrance X and the parking area A based on the positions of the guide devices 210 and 220 to guide the vehicle 1 towards the parking area A so that the vehicle 1 enters the parking area A through the entrance X.

According to the embodiment including the aforementioned construction, the parking guidance apparatus 100 specifies the positions of the guide devices 210 and 220 using the transmission waves from the guide devices 210 and 220 to appropriately specify the parking area A provided conforming to the positions of the guide devices 210 and 220, without using an image, for example, which may be easily influenced by environment. The vehicle 1 is thus accurately guided to the parking area A without being influenced by environment.

The estimation processor 102 calculates a distance difference between a transmission distance of the transmission wave between the guide device 210 (220) and the first onboard receiver and a transmission distance of the transmission wave between the guide device 210 (220) and the second onboard receiver in accordance with the time difference between the first timing and the second timing. The estimation processor 102 then estimates the position of the guide device 210 (220) based on the aforementioned distance difference. The position of the guide device 210 (220) is simply estimated by calculating the distance difference between the two transmission distances accordingly.

Specifically, the estimation processor 102 calculates the distance difference based on the aforementioned time difference at least in two cases including the first case where the vehicle 1 is located at the first position and the second case where the vehicle 1 is located at the second position different from the first position, and estimates the candidate for the position of each of the guide devices 210 and 220 based on the calculated distance difference. The estimation processor 120 then estimates the position of each of the guide devices 210 and 220 based on the first candidate estimated in the first case, the second candidate estimated in the second case, and the positional relation between the first position and the second position. The position of each of the guide devices 210 and 220 may be accurately estimated by specifying the position at which the two candidates obtained by at least two estimations conform to each other.

The estimation processor 102 obtains the positional relation between the first position and the second position based on the moving distance of the vehicle 1 between the first position and the second position that is calculated from the output value of the driving state sensor 130 provided at the vehicle 1 for detecting the driving state of the vehicle 1. The positional relation between the first position and the second position that is required for specifying the position of each of the guide devices 210 and 220 by at least two estimations is easily obtainable from the output value of the driving state sensor 130.

In the embodiment, the reception processor 101 receives the transmission waves through at least two object detectors 110 (for example, the object detectors 111S and 112S) fixedly provided at different positions from each other at the lateral end portion of the vehicle 1. The position of each of the guide devices 210 and 220 may be easily specified using at least two object detectors 110 provided at the lateral end portion of the vehicle 1 where the transmission wave from each of the guide devices 210 and 220 may be easily received.

The reception processor 101 employs, as at least two onboard receivers receiving the transmission waves from the guide devices 210 and 220, the object detectors 110 constituted by sonars that detect information related to an object in surroundings of the vehicle 1 by transmitting and receiving sound waves. The aforementioned construction inhibits an exclusive configuration for receiving the transmission waves from the guide devices 210 and 220 and enables easy reception of the transmission waves from the guide devices 210 and 220 using the sonars.

The aforementioned embodiment is achieved with transmission and reception of ultrasonic waves. Alternatively, the embodiment is achievable with transmission and reception of sound waves, millimeter waves, and electromagnetic waves, for example.

In the embodiment, the single guide device is provided at the position corresponding to each of the opposed ends of the entrance of the parking area, i.e., two guide devices are provided as the ground apparatus. The number of guide devices is not limited to two. The single guide device is acceptable in a state where the guide device is associated with the parking area (and the entrance) on a one-to-one basis so that the parking area (and the entrance) is appropriately specified in accordance with the estimation result of the position of the guide device. In the same manner, three or more than three guide devices are acceptable as long as the positions of such guide devices are appropriately specified in accordance with the estimation result of the positions of the guide devices.

In the embodiment, the stopper device is provided in addition to and separately from the two guide devices which are employed for specifying the parking area and the entrance X. The stopper device is provided to stop or park the vehicle at an appropriate position within the parking area. In a modified example, the stopper device may not be provided. Specifically, the vehicle may be stopped at an appropriate position without the stopper device being provided in a state where a process for specifying a target stop position of the vehicle at a predetermined position within the parking area A is performed together with the process for specifying the parking area based on the position of the guide device.

In the embodiment, the guide control is terminated around timing at which the signal level of the transmission wave from the stopper device that is received through the object detector shows the peak level so as to stop the vehicle at an appropriate position within the parking area. The embodiment also includes a construction where the position of the stopper device is estimated in the same manner as the estimation of positions of the guide devices and an appropriate position within the parking area is determined in accordance with the estimation result for stopping the vehicle, so that the guide control is terminated around timing at which the vehicle reaches the aforementioned appropriate position.

In the embodiment, the transmission wave from the ground apparatus is received through the object detectors functioning as sonars. Alternatively, the transmission wave from the ground apparatus may be received by exclusive onboard receivers that are separately provided from the sonars.

The embodiment and the modified examples thereof are not limited to include the aforementioned configurations. Omissions, replacements, and changes may be appropriately conducted for the embodiment and the modified examples thereof, for example.

According to the embodiment, a parking guidance apparatus 100 provided at a vehicle 1 includes a reception processor 101 receiving a transmission wave transmitted from a ground apparatus 200 that is fixedly provided on a ground, the reception processor 101 receiving the transmission wave through at least two object detectors 110 fixedly provided at different positions from each other at the vehicle 1, the at least two object detectors 110 including a first object detector 111S and a second object detector 112S that are different from each other, an estimation processor 102 estimating a position of the ground apparatus 200 relative to a position of the vehicle 1 in accordance with a time difference between a first timing and a second timing, the first timing at which the transmission wave is received by the reception processor 101 through the first object detector 111S, the second timing at which the transmission wave is received by the reception processor 101 through the second object detector 112S, and a guide processor 103 specifying a parking area A in accordance with the position of the ground apparatus 200 estimated by the estimation processor 102 and guiding the vehicle 1 towards the parking area A, the parking area A conforming to the position of the ground apparatus 200.

In addition, the estimation processor 102 estimates the position of the ground apparatus 200 based on a distance difference between a first transmission distance of the transmission wave between the ground apparatus 200 and the first object detector 111S and a second transmission distance of the transmission wave between the ground apparatus 200 and the second object detector 112S, the distance difference being calculated on a basis of the time difference between the first timing and the second timing.

Further, the estimation processor 102 calculates the distance difference based on the time difference in at least two cases including a first case where the vehicle 1 is in a first position and a second case where the vehicle 1 is in a second position different from the first position, estimates a candidate for the position of the ground apparatus 200 based on the distance difference, and estimates the position of the ground apparatus 200 based on a first candidate serving as the candidate estimated in the first case, a second candidate serving as the candidate estimated in the second case, and a positional relation between the first position and the second position.

Furthermore, the estimation processor 102 acquires the positional relation between the first position and the second position in accordance with a moving distance of the vehicle 1 between the first position and the second position, the moving distance being calculated on a basis of an output value of a driving state sensor provided at the vehicle 1 for detecting a driving state of the vehicle 1.

Furthermore, the reception processor 101 receives the transmission waves transmitted from a first ground device 210 and a second ground device 220 each of which serves as the ground apparatus 200 through the at least two object detectors 110, the first ground device 210 and the second ground device 220 being provided at positions corresponding to opposed ends of an entrance X of the parking area A through which the vehicle 1 enters, the opposed ends of the entrance X being opposed in a width direction of the entrance X. The guide processor 103 estimates a position of the first ground device 210 based on the transmission wave transmitted from the first ground device 210 and estimates a position of the second ground device 220 based on the transmission wave transmitted from the second ground device 220. The guide processor 103 specifies the entrance X and the parking area A based on the position of the first ground device 210 and the position of the second ground device 220 estimated by the estimation processor 102 and guides the vehicle 1 towards the parking area A to cause the vehicle 1 to enter the parking area A through the entrance X.

The entrance X and the parking area A may be thus easily specified by specifying the positions of the two ground devices 210 and 220.

Furthermore, the reception processor 101 receives the transmission waves through the at least two object detectors 111S, 112S fixedly provided at different positions from each other at a lateral end portion of the vehicle 1.

Furthermore, the reception processor 101 receives the transmission wave transmitted from the ground apparatus 20) through sonars serving as the at least two object detectors 111S, 112S and detecting information related to an object in surroundings of the vehicle 1 by transmitting and receiving a sound wave.

According to the embodiment, a parking guidance apparatus 100 includes a ground apparatus 200 fixedly provided on a ground and transmitting a transmission wave and a parking guidance apparatus 100 provided at a vehicle 1. The parking guidance apparatus 100 includes a reception processor 101 receiving a transmission wave transmitted from the ground apparatus 200, the reception processor 101 receiving the transmission wave through at least two object detectors 110 fixedly provided at different positions from each other at the vehicle 1, the at least two object detectors 110 including a first object detector 111S and a second object detector 112S that are different from each other, an estimation processor 102 estimating a position of the ground apparatus 200 relative to a position of the vehicle 1 in accordance with a time difference between a first timing and a second timing, the first timing at which the transmission wave is received by the reception processor 101 through the first object detector 111S, the second timing at which the transmission wave is received by the reception processor 101 through the second object detector 112S, and a guide processor 103 specifying a parking area A in accordance with the position of the ground apparatus 200 estimated by the estimation processor 102 and guiding the vehicle 1 towards the parking area A, the parking area A conforming to the position of the ground apparatus 200.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A parking guidance apparatus provided at a vehicle, the parking guidance apparatus comprising:
a reception processor receiving a transmission wave transmitted from a ground apparatus that is fixedly provided on a ground, the reception processor receiving the transmission wave through at least two onboard receivers fixedly provided at different positions from each other at the vehicle, the at least two onboard receivers including a first onboard receiver and a second onboard receiver that are different from each other;
an estimation processor estimating a position of the ground apparatus relative to a position of the vehicle in accordance with a time difference between a first timing and a second timing, the first timing at which the transmission wave is received by the reception processor through the first onboard receiver, the second timing at which the transmission wave is received by the reception processor through the second onboard receiver; and
a guide processor specifying a parking area in accordance with the position of the ground apparatus estimated by the estimation processor and guiding the vehicle towards the parking area, the parking area conforming to the position of the ground apparatus.

2. The parking guidance apparatus according to claim 1, wherein the estimation processor estimates the position of the ground apparatus based on a distance difference between a first transmission distance of the transmission wave between the ground apparatus and the first onboard receiver and a second transmission distance of the transmission wave between the ground apparatus and the second onboard receiver, the distance difference being calculated on a basis of the time difference between the first timing and the second timing.

3. The parking guidance apparatus according to claim 2, wherein the estimation processor calculates the distance difference based on the time difference in at least two cases including a first case where the vehicle is in a first position and a second case where the vehicle is in a second position different from the first position, estimates a candidate for the position of the ground apparatus based on the distance difference, and estimates the position of the ground apparatus based on a first candidate serving as the candidate estimated in the first case, a second candidate serving as the candidate estimated in the second case, and a positional relation between the first position and the second position.

4. The parking guidance apparatus according to claim 3, wherein the estimation processor acquires the positional relation between the first position and the second position in accordance with a moving distance of the vehicle between the first position and the second position, the moving distance being calculated on a basis of an output value of a driving state sensor provided at the vehicle for detecting a driving state of the vehicle.

5. The parking guidance apparatus according to claim 1, wherein
the reception processor receives the transmission waves transmitted from a first ground device and a second ground device each of which serves as the ground apparatus through the at least two onboard receivers, the first ground device and the second ground device being provided at positions corresponding to opposed ends of an entrance of the parking area through which the vehicle enters, the opposed ends of the entrance being opposed in a width direction of the entrance,
the guide processor estimates a position of the first ground device based on the transmission wave transmitted from the first ground device and estimates a position of the second ground device based on the transmission wave transmitted from the second ground device,
the guide processor specifies the entrance and the parking area based on the position of the first ground device and the position of the second ground device estimated by the estimation processor and guides the vehicle towards the parking area to cause the vehicle to enter the parking area through the entrance.

6. The parking guidance apparatus according to claim 1, wherein the reception processor receives the transmission waves through the at least two onboard receivers fixedly provided at different positions from each other at a lateral end portion of the vehicle.

7. The parking guidance apparatus according to claim 2, wherein the reception processor receives the transmission waves through the at least two onboard receivers fixedly provided at different positions from each other at a lateral end portion of the vehicle.

8. The parking guidance apparatus according to claim 3, wherein the reception processor receives the transmission waves through the at least two onboard receivers fixedly provided at different positions from each other at a lateral end portion of the vehicle.

9. The parking guidance apparatus according to claim 4, wherein the reception processor receives the transmission waves through the at least two onboard receivers fixedly provided at different positions from each other at a lateral end portion of the vehicle.

10. The parking guidance apparatus according to claim 1, wherein the reception processor receives the transmission wave transmitted from the ground apparatus through sonars serving as the at least two onboard receivers and detecting information related to an object in surroundings of the vehicle by transmitting and receiving a sound wave.

11. The parking guidance apparatus according to claim 2, wherein the reception processor receives the transmission wave transmitted from the ground apparatus through sonars serving as the at least two onboard receivers and detecting information related to an object in surroundings of the vehicle by transmitting and receiving a sound wave.

12. The parking guidance apparatus according to claim 3, wherein the reception processor receives the transmission wave transmitted from the ground apparatus through sonars serving as the at least two onboard receivers and detecting information related to an object in surroundings of the vehicle by transmitting and receiving a sound wave.

13. The parking guidance apparatus according to claim 4, wherein the reception processor receives the transmission wave transmitted from the ground apparatus through sonars serving as the at least two onboard receivers and detecting information related to an object in surroundings of the vehicle by transmitting and receiving a sound wave.

14. A parking guidance apparatus comprising:
a ground apparatus fixedly provided on a ground and transmitting a transmission wave; and
a parking guidance apparatus provided at a vehicle,
the parking guidance apparatus including:
a reception processor receiving a transmission wave transmitted from the ground apparatus, the reception processor receiving the transmission wave through at least two onboard receivers fixedly provided at different positions from each other at the vehicle, the at least two onboard receivers including a first onboard receiver and a second onboard receiver that are different from each other;
an estimation processor estimating a position of the ground apparatus relative to a position of the vehicle in accordance with a time difference between a first timing and a second timing, the first timing at which the transmission wave is received by the reception processor through the first onboard receiver, the second timing at which the transmission wave is received by the reception processor through the second onboard receiver; and
a guide processor specifying a parking area in accordance with the position of the ground apparatus estimated by the estimation processor and guiding the vehicle towards the parking area, the parking area conforming to the position of the ground apparatus.
